(19) United States
(12) Patent Application Publication
(10) Pub. No.: US 2005/0196636 A1
(43) Pub. Date: Sep. 8, 2005

(54) Decorative article, method of manufacturing same, and timepiece

(75) Inventors: Atsushi Kawakami, Matsumoto-shi (JP); Yoshiyuki Obi, Chino-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Seiko Epson Corporation, Tokyo (JP)

(21) Appl. No.: 11/048,057

(22) Filed: Feb. 2, 2005

(30) Foreign Application Priority Data
Feb. 2, 2004 (JP) 2004-026129

(51) Int. Cl. B32B 15/00

(52) U.S. Cl. 428/660; 428/632; 428/633

(57) ABSTRACT

A decorative article 1 includes a substrate 2 formed mainly of plastic material, an oxide coating 3 formed mainly of metal oxide material provided on the substrate 2, and a metal coating 4 formed mainly of metal material provided on a surface of the oxide coating 3 on a side opposite the surface of the oxide coating 3 that is adjacent the substrate 2. It is desirable that the oxide coating 3 is formed of a material including at least one material selected from among TiO₂ and CrO. It is further desirable that the metal coating 4 is formed of a material including at least one material selected from among Ag, Cr, Au, Al, Ti, Sn, and In. It is still further desirable that the sum of the average thickness of the oxide coating 3 and the average thickness of the metal coating 4 is 0.02 to 2.5 μm.

### BACKGROUND OF THE INVENTION

1. Field of the Invention

The present invention generally relates to a decorative article. More specifically, the present invention relates to a decorative article, decorative article manufacturing method, and watch.

2. Background Information

The decorative article used on external decorative articles on watches must have an excellent aesthetic appearance. Conventionally, metal materials such as Au, Ag and the like are generally used as structural materials of decorative articles for this purpose. There have been attempts at using plastics as a substrate and forming a coating of metal material on this substrate for the purpose of improving the degree of freedom in decorative article formation and to reduce manufacturing costs for example, as shown in Japanese Laid-Open Patent Publication No. 2003-239083 (Page 4, left column, lines 37 to 42). Japanese Laid-Open Patent Publication No. 2003-239083 is hereby incorporated by reference. Plastics, however, generally do not adhere well to metal materials. Therefore, problems arise inasmuch as peeling readily occurs between the substrate and the coating, and the decorative articles have poor durability.

In view of the above, it will be apparent to those skilled in the art from this disclosure that there exists a need for an improved a decorative article, decorative article manufacturing method, and watch. This invention addresses this need in the art as well as other needs, which will become apparent to those skilled in the art from this disclosure.

### SUMMARY OF THE INVENTION

Objects of the present invention includes providing a decorative article having a substrate formed mainly of plastic material and possessing excellent aesthetic appearance and durability, providing a manufacturing method capable of producing the decorative article, and providing a watch having the decorative article. The aforementioned objects are attained by the present invention described below.

A decorative article in accordance with a first aspect of the present invention has a substrate formed mainly of plastic material, an oxide coating formed mainly of a metal oxide provided on the substrate, and a metal coating formed mainly of a metal material provided on the surface of the oxide coating on the side opposite the side adjacent the substrate. Consequently, the invention provides a decorative article with a substrate formed mainly of plastic material, and having an excellent aesthetic appearance and durability.

A decorative article in accordance with a second aspect of the present invention is the decorative article of the first aspect, wherein it is desirable that the substrate is formed of material that includes at least one type selected from among polycarbonate, and acrylonitrile-butadiene-styrene copolymer (ABS resin). Consequently, the decorative article has excellent overall strength, and there is increased freedom in formation of the decorative article when manufacturing the decorative article (improved ease of formation).

A decorative article in accordance with a third aspect of the present invention is the decorative article of the first or second aspect, wherein it is desirable that the oxide coating is formed of material that includes at least one substance selected from the group having titanium oxide and chromium oxide. Consequently, the decorative article has better and excellent adhesion between the substrate and metal coating.

A decorative article in accordance with a fourth aspect of the present invention is the decorative article of any one of the first to the third aspects, wherein it is desirable that the average thickness of the oxide coating is 0.01 to 1.0 μm. Consequently, there is sufficient prevention of an increase in internal stress in the oxide coating, and the decorative article has exceptional adhesion between the substrate and metal coating.

A decorative article in accordance with a fifth aspect of the present invention is the decorative article of any one of the first to fourth aspects, wherein it is desirable that the metal coating is formed of material that includes at least one substance selected from the group having Ag, Cr, Au, Al, Ti, Sn, and In. Consequently, the decorative article has excellent adhesion between the metal coating and oxide coating, and has a particularly excellent aesthetic appearance.

A decorative article in accordance with a sixth aspect of the present invention is the decorative article of any one of the first to fifth aspects, wherein it is desirable that the average thickness of the metal coating is 0.01 to 1.5 μm. Consequently, there is sufficient prevention of an increase in internal stress in the metal coating, and the decorative article has exceptional adhesion between the oxide coating and metal coating.

A decorative article in accordance with a seventh aspect of the present invention is the decorative article of any one of the first to sixth aspects, wherein it is desirable that the sum of the average thickness of the oxide coating and the average thickness of the metal coating is 0.02 to 2.5 μm. Consequently, there is sufficient prevention of an increase in internal stress in the oxide coating and metal coating, and the decorative article has exceptional adhesion between the substrate, oxide coating, and metal coating. Furthermore, when the sum of the average thickness of the oxide coating and the average thickness of the metal coating is a value within the aforesaid range, radio wave transmittance is improved for the entire decorative article. As a result, the decorative article is optimally suited as a component of a radio watch.

A decorative article in accordance with a eighth aspect of the present invention is the decorative article of any one of the first to seventh aspects, wherein it is desirable that a cover layer formed mainly of resin material is provided on top of the metal coating. Consequently, for example, a decorative article having even greater aesthetic appeal can be obtained. Furthermore, even more reliable prevention of degradation and degeneration of the metal coating and the like due to the influence of the external environment is obtained, and exceptional durability is achieved as a decorative article.

A decorative article in accordance with a ninth aspect of the present invention is the decorative article of any one of the first to eighth aspects, wherein it is desirable that the cover layer is formed mainly of urethane resin and/or acrylic resin. Consequently, exceptional adhesion of the cover layer is obtained.

A decorative article in accordance with a tenth aspect of the present invention is the decorative article of any one of the first to ninth aspects, wherein the decorative article is desirably an external decorative article of a watch. External components of a watch are generally decorative articles which readily receive external impacts. Such parts must have an attractive appearance as decorative articles, and must also be durable as useful elements. The present invention satisfies both requirements simultaneously.

The decorative article in accordance with a eleventh aspect of the present invention is the decorative article of any one of the first to tenth aspects, wherein the decorative article is desirably a component of a radio watch. The decorative article of the present invention has an aesthetic appearance and superior durability, and since the substrate is formed of plastic material, also has excellent transmittance of radio waves. Accordingly, the decorative article of the present invention is optimally suited for use in radio watch components.

A decorative article manufacturing method in accordance with a twelfth aspect of the present invention is the decorative article of the present invention is a method for manufacturing any of the previously described decorative articles. The method includes an oxide coating forming process to form an oxide coating mainly of metal oxide on at least part of the surface of the substrate formed mainly of plastic material, and a metal coating forming process to form a metal coating mainly of metal material on at least part of the surface of the oxide coating. Consequently, this method of manufacturing a decorative article is capable of producing a decorative article provided with a substrate formed mainly of plastic material and having excellent aesthetic appearance and durability.

A decorative article manufacturing method in accordance with a thirteenth aspect of the present invention is the method of the twelfth aspect, wherein it is desirable that the oxide coating forming process is accomplished by a vapor-phase layer forming method. Consequently, an oxide coating can be reliably formed with a uniform layer thickness and particularly excellent adhesion with the substrate. As a result, an aesthetic appearance and exceptional durability are obtained fourth decorative article. Furthermore, radio wave transmittance of the decorative article is improved since variance in the layer thickness is sufficiently minimized even when the oxide coating is formed comparatively thin.

A decorative article manufacturing method in accordance with a fourteenth aspect of the present invention is the method of the thirteenth aspect, wherein it is desirable that the oxide coating forming process is accomplished by a sputtering method. Consequently, an oxide coating can be even more reliably formed with a uniform layer thickness and particularly excellent adhesion with the substrate. As a result, an aesthetic appearance and exceptional durability are realized for the decorative article. A further advantage is that radio wave transmittance of the decorative article is improved since variance in the layer thickness is sufficiently minimized even when the oxide coating is formed comparatively thin.

A decorative article manufacturing method in accordance with a fifteenth aspect of the present invention is the method of any of the twelfth to fourteenth aspects, wherein it is desirable that the metal coating forming process is accomplished by a vapor-phase layer forming method. Consequently, a metal coating can be reliably formed with a uniform layer thickness and particularly excellent adhesion with the oxide coating. As a result, an aesthetic appearance and exceptional durability are obtained for the decorative article. Furthermore, radio wave transmittance of the decorative article is improved because variance in the layer thickness is sufficiently minimized even when the metal coating is formed comparatively thin.

A decorative article manufacturing method in accordance with a sixteenth aspect of the present invention is the method of the fifteenth aspects, wherein it is desirable that the metal coating forming process is accomplished by a sputtering method. Consequently, a metal coating can be even more reliably formed to have a uniform layer thickness and particularly excellent adhesion with the oxide coating. As a result, an aesthetic appearance and exceptional durability are obtained for the decorative article. A further advantage is that radio wave transmittance of the decorative article is improved because variance in the layer thickness is sufficiently minimized even when the oxide coating is formed comparatively thin.

A decorative article manufacturing method in accordance with a seventeenth aspect of the present invention is the method of any of the twelfth to sixteenth aspects, wherein it is desirable to have a cover layer forming process to form a cover layer mainly of resin material after the metal coating forming process. Consequently, for example, a decorative article having even greater aesthetic appeal can be obtained. Furthermore, even more reliable prevention of degradation and degeneration of the metal coating and the like due to the influence of the external environment are obtained, and exceptional durability realized for the decorative article.

The watch of the present invention in accordance with a eighteenth aspect of the present invention is provided with the decorative article of any one of the first to eleventh aspects. Consequently, a watch is provided with a decorative article that has excellent aesthetic appearance and durability.

The present invention provides a decorative article having a substrate formed mainly of plastic material and possessing superior aesthetic appearance and durability, a manufacturing method capable of providing the decorative article, and further provides a watch including the decorative article.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a cross section view of a decorative article in accordance with a first preferred embodiment of the present invention;

FIG. 2 illustrates cross section views showing a decorative article manufacturing method for the decorative article of the present invention;

FIG. 3 is a partial cross section view of the timepiece (portable) of the present invention;

FIG. 4 is a view of a table showing results of using the decorative article manufacturing method;

FIG. 5 is a view of a table showing additional results of using the decorative article manufacturing method;

FIG. 6 is a perspective view showing a timepiece having the decorative article of the present invention; and

FIG. 7 is a cross-sectional view of a part of the timepiece.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

The preferred embodiments of the decorative article, decorative article manufacturing method, and watch of the present invention are described hereinafter with reference to the accompanying drawings. First the preferred embodiments of the decorative article of the present invention are described.

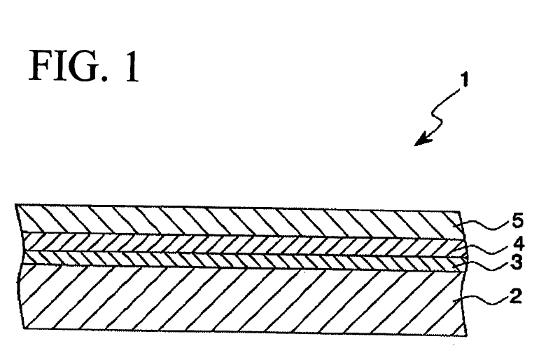

FIG. 1 shows a decorative article in accordance with a preferred embodiment of the present invention. As shown in FIG. 1, the decorative article 1 of the present embodiment includes a substrate 2, oxide coating 3, metal coating 4, and cover layer 5.

Substrate

The substrate 2 is formed mainly of plastic material. Plastic materials that form the substrate 2 include various types of thermoplastic resins and various types of thermosetting resins, for example, polyolefins such as polyethylene, polypropylene, ethylene-propylene copolymer, ethylene-vinyl acetate copolymer (EVA) and the like, cyclic polyolefins, modified polyolefins, polyesters such as polyvinyl chloride, polyvinylidene chloride, polystyrene, polyamide (for example, nylon 6, nylon 46, nylon 66, nylon 610, nylon 612, nylon 11, nylon 12, nylon 6-12, nylon 6-66), polyimide, polyamidoimide, polycarbonate (PC), poly-(4-methylpentene-1), aionomer, acrylic resin, polymethyl methacrylate, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyethylene terephthalate (PET), polybutylene terephthalate (PBT), polycyclohexane terephthalate (PCT) and the like, various types of thermoplastic elastomers such as polyether, polyether ketone (PEK), polyether ether ketone (PEEK), polyether imide, polyacetal (POM), polyphenylene oxide, modified polyphenylene oxide, polysulfone, polyether sulfone, polyphenylene sulfide, polyarylate, aromatic polyester (liquid crystal polymer), polytetraflouro ethylene, polyvinylidene fluoride, other fluororesins, styrene, polyolefins, polyvinyl chloride, polyurethane, polyester, polyamide, polybutadiene, transpolyisoprene, fluororubber, polyethylene chloride and the like, poly-para-xylylene resins such as epoxy resin, phenol resin, urea resin, melamine resin, unsaturated polyester, silicone resin, urethane resin, poly-para-xylylene, poly-monochloro-para-xylylene, poly-dichloro-para-xylylene, poly-monofluoro-para-xylylene, poly-monoethyl-para-xylylene and the like, main copolymers, blends, and polymer alloys thereof, and combinations of one type, two types, or more than two types thereof (for example, blended resins, polymer alloys, laminates).

The substrate 2 is desirably formed of material containing at least one type of material selected from among the aforesaid materials, particularly polycarbonate (PC), and acrylonitrile-butadiene-styrene copolymer (ABS resin). Consequently, the manufactured object particularly provides superior strength to the entire decorative article 1. Furthermore, since a greater degree of freedom is obtained in the configuration of the substrate 2 (improved ease of formation) when manufacturing the decorative article 1, the decorative article can be reliably and easily manufactured even when the decorative article 1 has a more complex configuration. Additionally, polycarbonate is comparatively inexpensive among the various types of plastic materials, thus the cost of mass production of the decorative article 1 can be reduced. ABS resin is particularly chemical resistant, and improves the durability of the entire decorative article 1.

The substrate 2 may also include constituents other than plastic materials. Useful examples of such constituents include plasticizers, antioxidants, colorants (including various types of color formers, fluorescent materials, phosphorescent materials and the like), glossing agent, filler, and the like. Part of the substrate 2 also may be formed of material that does not include plastic material, for example, insofar as at least the part near the surface (the part formed by the oxide coating 3 described later) is formed mainly of plastic material.

The substrate 2 also may have a substantially uniform composition in each part, and the composition may differ according to the part. For example, the substrate 2 may have a surface layer superimposed on a base layer. In the case of a substrate 2 having such a structure, at least the part near the surface (the part formed by the oxide coating layer 3 described later) may be formed mainly of plastic material as previously described.

The shape and size of the substrate 2 is not specifically limited, and is normally determined based on the size and shape of the decorative article 1. The substrate 2 may be formed by many methods, such as, for example, compression molding, extrusion molding, injection molding, optical molding and the like.

Oxide Coating

An oxide coating 3 is provided on the surface of the substrate 2. Therefore, a characteristic of the present invention is that an oxide coating 3 is provided between the substrate 2 and a metal coating 4. Further, the metal coating 4 is not provided directly on the surface of the substrate 2 formed mainly of plastic material. Consequently, the adhesion between the metal coating 4and the substrate 2 (adhesion mediated by the oxide coating 3) is improved, and peeling and lifting of the metal coating 4 is effectively prevented. As a result, the decorative article 1 has excellent durability. Furthermore, the decorative article 1 possesses superior aesthetic appeal since it has the metal coating 4.

The oxide coating 3 is formed mainly of metal oxide. Examples of types of oxides of metals that are suitable as the metal oxide of the oxide coating 3 preferably include Fe, Cu, Zn, Ni, Mg, Cr, Mn, Mo, Nb, Al, V, Zr, Sn, Au, Pd, Pt, Ag, Co, In, W, Ti, Rh (including metal oxide compounds). It is desirable that the oxide coating 3 is formed of material including at least one type selected among titanium oxide (including complex oxides), and chromium oxide (including complex oxides) among the materials mentioned above. Consequently, even better and superior adhesion is obtained between the substrate 2 and metal coating 4. The oxide coating 3 also may contain constituents other than metal oxide.

The average thickness of the oxide coating 3 is not specifically limited, however, an average thickness of 0.01 to 1.0 μm is desirable, 0.01 to 0.5 μm is more desirable, and 0.01 to 0.3 μm is most desirable. When the average thickness of the oxide coating 3 is a value within this range, an increase in the internal stress of the oxide coating 3 is sufficiently prevented, and very superior adhesion is obtained between the substrate 2 and the metal coating 4. In contrast, when the average thickness of the oxide coating 3 is less than the lower limit value, it may be difficult to improve sufficiently the adhesion between the substrate 2 and the metal coating 4 by the structural materials of the oxide coating 3, substrate 2, and metal coating 4. Furthermore, when the average thickness of the oxide coating 3 is less than the lower limit value, pinholes readily occur in the oxide coating 3, and the effect to be obtained by providing the oxide coating 3 may be not be sufficient through the forming method of the oxide coating 3. When the average thickness of the oxide coating 3 exceeds the upper limit, there is a tendency toward large variance in the layer thickness at each part of the oxide coating 3. Moreover, when the average thickness of the oxide coating 3 is particularly large, the internal stress increases in the oxide coating 3, and cracking and the like readily occurs.

The oxide coating 3 may or may not have a uniform composition in each part. For example, the oxide coating 3 may have a sequentially variable content (composition) in the thickness direction (gradient material). The oxide coating 3 also may be a laminate body having a plurality of layers. It is possible to improve adhesion between the substrate 2 and the metal coating 4 in this way, for example. More specifically, adhesion between the substrate 2 and metal coating 4 can be improved even more by providing a laminate body in which a material having excellent adhesion with the substrate 2 is used in the layer in contact with the substrate 2, and a laminate body in which a material having excellent adhesion with the metal coating 4 is used in the layer in contact with the metal coating 4. When the oxide coating 3 is a laminate body, for example, it may have a layer formed of material which does not substantially contain metal oxide. More specifically, the oxide coating 3 also may have a structure that interposes a layer formed of plastic material between two layers formed of metal oxide.

Metal Coating

A metal coating 4 is provided on the surface of the oxide coating 3 (the surface of oxide coating 3 that is on the side opposite the side in contact with the substrate 2). The metal coating 4 is formed mainly of metal material. Various types of metal (including alloys) can be used as the metal material to form the metal coating 4; examples of desirable metals include Fe, Cu, Zn, Ni, Mg, Cr, Mn, Mo, Nb, Al, V, Zr, Sn, Au, Pd, Pt, Ag, Co, In, W, Ti, Rh, and alloys containing at least one or more of these types of metals. The metal coating 4 is desirably formed of material including at least one type selected from among Ag, Cr, Au, Al, Ti, Sn, and In among the materials (including alloys) listed above. Consequently, excellent adhesion is obtained between the metal coating 4 and the oxide coating 3, and the decorative article 1 is provided with exceptional aesthetic appeal. The metal coating 4 also may contain constituents other than metal material.

The structural material of the metal coating 4 also may include at least one type element which forms the oxide coating 3. That is, at least the parts of the oxide coating 3 and metal coating 4 that are in contact may be formed of materials that contain mutually common elements. For example, when the oxide coating 3 includes a metal oxide compound represented the composition formula MOn/2 (where M represents a metal element, and n represents the valence number of M), the metal coating 4 also may contain M. Consequently, adhesion is improved between the oxide coating 3 and metal coating 4.

The average thickness of the metal coating 4 is not specifically limited, however, an average thickness of 0.01 to 1.5 μm is desirable, 0.01 to 0.9 μm is more desirable, and 0.01 to 0.5 μm is most desirable. When the average thickness of the metal coating 4 is a value within this range, an increase in the internal stress of the metal coating 4 is sufficiently prevented, and the decorative article 1 is provided with exceptional aesthetic appeal. In contrast, when the average thickness of the metal coating 4 is less than the lower limit value, it may be difficult for the metal coating 4 to manifest adequately glossiness and color tone via the structural materials of the metal coating 4, thus making it difficult to obtain sufficient overall aesthetic appeal in the decorative article 1. Furthermore, when the average thickness of the metal coating 4 is less than the lower limit value, pinholes readily occur in the metal coating 4 through the forming method of the metal coating 4. It may also prove difficult to improve sufficiently adhesion between the oxide coating 3 and metal coating 4 through the structural materials of the metal coating 3 and metal coating 4. When the average thickness of the metal coating 4 exceeds the upper limit, there is a tendency toward large variance in the layer thickness at each part of the metal coating 4. Moreover, when the average thickness of the metal coating 4 is particularly large, the internal stress increases in the metal coating 4, and cracking and the like readily occurs.

The metal coating 4 may or may not have a uniform composition in each part. For example, the metal coating 4 may have a sequentially variable content (composition) in the thickness direction (gradient material). The metal coating 4 also may be a laminate body having a plurality of layers. It is possible to improve adhesion between the substrate 2 and the metal coating 4 in this way, as well as improve the aesthetic appeal of the decorative article 1, for example.

In other words, exceptional adhesion with the oxide coating 3 can be obtained, and heightened aesthetic appeal of the decorative article 1 can be achieved by providing a laminate body in which a material having excellent adhesion with the oxide coating 3 is used in the layer in contact with the oxide coating 3. Further, a laminate body in which a material having excellent aesthetic qualities used in the outermost layer (layer farthest away from the oxide coating 3) can also be realized. When the metal coating 4 is a laminate body, for example, it may have a layer formed of material that does not substantially contain metal material. More specifically, the metal coating 4 also may have a structure that interposes a layer formed of metal oxide and the like between two layers formed of metal material.

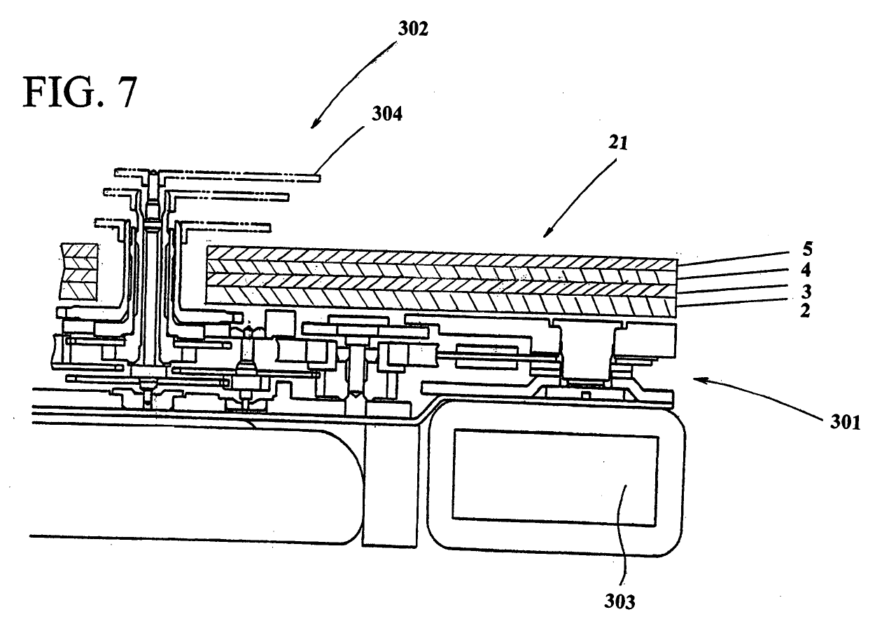

The sum of the average thickness of the oxide coating 3 and the average thickness of the metal coating 4 is desirably 0.02 to 2.5 μm, more desirably 0.02 to 1.5 μm, and most desirably 0.02 to 0.8 μm. When the sum of the average thickness of the oxide coating 3 and the average thickness of the metal coating 4 is a value within this range, an increase in the internal stress of the oxide coating 3 and metal coating 4 is sufficiently prevented, and exceptional adhesion is obtained among the substrate 2, oxide coating 3, and metal coating 4. Furthermore, when the sum of the average thickness of the oxide coating 3 and the average thickness of the metal coating 4 is a value within this range, radio wave transmittance is improved for the entire decorative article. As a result, the decorative article is optimally suited as a component 303 of a radio watch as shown in FIG. 7.

Cover Layer

Referring again to FIG. 1, a cover layer 5 is provided on the surface (the surface on the side opposite the side in contact with the oxide coating 3) of the metal coating 4. The presence of the cover layer 5 allows the preparation of, for example, glossiness and color tone which produces a decorative article 1 of exceptional aesthetic appeal. Furthermore, the presence of the cover layer 5 can also enhance various characteristics of the entire decorative article 1, such as, for example, corrosion resistance, weather resistance, water resistance, oil resistance, abrasion resistance, wear resistance, discoloration resistance and the like, and reliably prevent degradation and degeneration of the metal coating 4 due to factors of the external environment. As a result, the decorative article 1 has exceptional durability.

Although the cover layer 5 may be formed of various materials, it is desirable that the cover layer is formed of material having suitable transparency. Examples of such materials include various types of plastics (resin materials), various glasses, diamond-like carbon (DLC) and the like, although among these materials, plastics are preferable due to their excellent transmittancy and excellent formability (ease of molding).

Plastic materials that forms the cover layer 5 include various types of thermoplastic resins and various types of thermosetting resins, for example, polyolefins such as polyethylene, polypropylene, ethylene-propylene copolymer, ethylene-vinyl acetate copolymer (EVA) and the like, cyclic polyolefins, modified polyolefins, polyesters such as polyvinyl chloride, polyvinylidene chloride, polystyrene, polyamide (for example, nylon 6, nylon 46, nylon 66, nylon 610, nylon 612, nylon 11, nylon 12, nylon 6-12, nylon 6-66), polyimide, polyamidoimide, polycarbonate (PC), poly-(4-methylpentene-1), aionomer, acrylic resin, polymethyl methacrylate, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyethylene terephthalate (PET), polybutylene terephthalate (PBT), polycyclohexane terephthalate (PCT) and the like, various types of thermoplastic elastomers such as polyether, polyether ketone (PEK), polyether ether ketone (PEEK), polyether imide, polyacetal (POM), polyphenylene oxide, modified polyphenylene oxide, polysulfone, polyether sulfone, polyphenylene sulfide, polyarylate, aromatic polyester (liquid crystal polymer), polytetraflouro ethylene, polyvinylidene fluoride, other fluororesins, styrene, polyolefins, polyvinyl chloride, polyurethane, polyester, polyamide, polybutadiene, transpolyisoprene, fluororubber, polyethylene chloride and the like, poly-para-xylylene resins such as epoxy resin, phenol resin, urea resin, melamine resin, unsaturated polyester, silicone resin, urethane resin, poly-para-xylylene, poly-monochloro-para-xylylene, poly-dichloro-para-xylylene, poly-monofluoro-para-xylylene, poly-monoethyl-para-xylylene and the like, main copolymers, blends, and polymer alloys thereof, and combinations of one type, two types, or more than two types thereof (for example, blended resins, polymer alloys, laminates).

Among the aforesaid materials, the cover layer 5 is desirably formed of material containing urethane resin and/or acrylic resin, and more desirably formed mainly of urethane resin and/or acrylic resin. In this way exceptional adhesion is obtained between the cover layer 5 and the metal coating 4.

The cover layer 5 also may contain constituents other than the materials mentioned above. Examples of such other materials include colorants (including various types of color formers, fluorescent material, phosphorescent materials and the like), glossing agent, plasticizer, antioxidant, filler and the like.

The average thickness of the cover layer 5 is not specifically limited, however, an average thickness of 0.01 to 50 μm is desirable, 0.1 to 20 μm is more desirable, and 2 to 15 μm is most desirable. When the average thickness of the cover layer 5 is a value within this range, an increase in the internal stress of the cover layer 5 is sufficiently prevented, and very superior adhesion is obtained between the cover layer 5 and the metal coating 4. In contrast, when the average thickness of the cover layer 5 is less than the lower limit value, it may be difficult to improve sufficiently the adhesion between the cover layer 5 and the metal coating 4 via the structural materials of the cover layer 5 and metal coating 4. Furthermore, there is a possibility that insufficient functionality will be obtained from the cover layer 5. When the average thickness of the cover layer 5 exceeds the upper limit, there is a tendency toward large variance in the layer thickness at each part of the cover layer 5. Moreover, when the average thickness of the cover layer 5 is particularly large, the internal stress increases in the cover layer 5, and cracking and the like readily occurs. Additionally, when the average thickness of the cover layer 5 is very large, it may be difficult to obtain sufficient glossiness and color tone of the metal coating 4, thus making it difficult to improve adequately the aesthetic appearance of the decorative article 1 overall.

The cover layer 5 may or may not have a uniform composition in each part. For example, the cover layer 5 may have a sequentially variable content (composition) in the thickness direction (gradient material). The cover layer 5 also may be a laminate body having a plurality of layers. It is possible to improve adhesion with the metal coating 4, and improve aesthetic appeal of the decorative article 1 in this way, for example.

The cover layer 5 also may be removed when using the decorative article 1, for example.

Decorative Article

The decorative article 1 described above may be an article provided with decoration, for example, interior and exterior articles for decorative articles and the like, jewelry, watch cases (body, back cover, one-piece case with integrated body and back cover), watch bands (mid-band, including band-bangle release mechanism), dials, watch hands, bezels (for example, rotating bezel), winding stems (for example, screw lock-type stem), buttons, cover glasses, glass edges, dial rings, parting plates, backings of watch exterior components, movement ground plates, gears, gear train bearings, watch internal components such as a rotor, eyeglasses (for example, eyeglass frame), necktie pins, cufflinks, finger rings, necklaces, bracelets, anklets, broaches, pendants, earrings, personal accessories for piercings, lighters and lighter cases, automobile steering wheels, sports equipment such as golf clubs, name plates, panels, trophies, various types of equipment that include housings, and various types of containers and the like. Among these, the decorative article 1 is especially desirable for the external parts of watches. External parts of watches generally are decorative articles susceptible to external impacts, which require an aesthetic appeal as decorative articles and durability as functional components, and these very requirements are simultaneously satisfied by the present invention. The ‘external component of watch’ in the specification of the present invention is not limited to components exposed on the outer parts of a watch and include internal parts within a watch insofar as such components are visible from the outside.

Furthermore, among the components of a watch (external components of a watch), the decorative article 1 is particularly desirable as the component 303 of radio watches for the previously stated reasons. In other words, the decorative article 1 has excellent aesthetic appeal and durability, and provides excellent radio wave transmittance because the substrate 2 is formed of plastic material. Accordingly, the decorative article I is optimally suited for the radio watch component 303.

The method for manufacturing the decorative article 1 is described below.

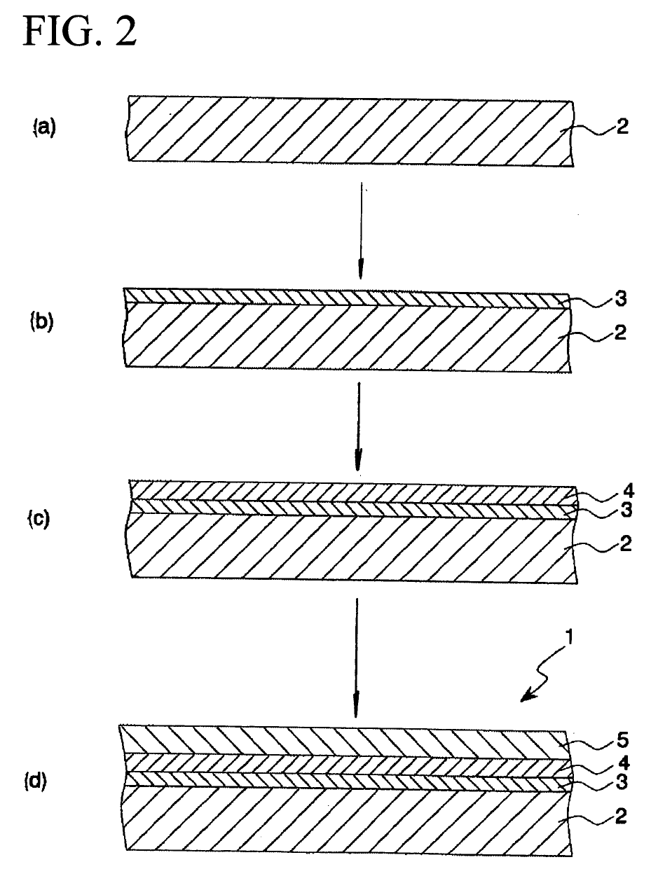

FIG. 2 is a cross section view of a preferred embodiment of the decorative article manufacturing method of the present invention.

As shown in FIG. 2, the decorative article manufacturing method of the present embodiment includes an oxide coating forming process (line b) to form an oxide coating 3 on at least part of the surface (line a) of a substrate 2, a metal coating 4 forming process (line c) to form a metal coating 4 on at least part of the surface of the oxide coating 3, and a cover layer forming process (line d) to form a cover layer 5 on the surface of the metal coating 4.

Substrate

The previously described object can be used as the substrate 2. The surface of the substrate 2 may be subjected to surface processing, such as, for example, a mirror finish process, seam process, matte finish process and the like. Consequently, it is possible to have variation in the degree of luster on the surface of the obtained decorative article 1, thereby enhancing the decorative articles of the obtained decorative article 1.

The decorative article 1 manufactured using the substrate 2, which has been subjected to the aforesaid surface processing, has an exceptional aesthetic appearance and suppresses cracking of the metal coating 4 compared to a case in which the oxide coating 3 or metal coating 4 is subjected to surface processing. Since the substrate 2 is formed mainly of plastic material, surface processing is comparatively easy. The oxide coating 3 and metal coating 4 normally are comparatively thin such that when the oxide coating 3 and metal coating 4 are subjected to surface processing, it is possible to remove completely the oxide coating 3 and metal coating 4. However, subjecting the substrate 2 to surface processing effectively eliminates this problem.

Oxide Coating Forming Process

As shown in line b of FIG. 2, and oxide coating 3 made mainly of metal oxide is formed on the substrate 2. An advantage of the present invention is that the durability of the entire decorative article 1 is improved by forming this oxide coating 3.

The method for forming the oxide coating 3 is not specifically limited. Examples of usable methods include applications such as spin coating, dip coating, brush application, spray application, electrostatic application, electro deposition and the like, wet plating methods such as electrolytic plating, immersion plating, electroless plating and the like, chemical deposition methods (CVD) such as heat CVD, plasma CVD, laser CVD and the like, dry plating methods (vapor-phase film formation) such as vacuum vapor deposition, sputtering, ion plating and the like, and spray coating and the like, among which the dry plating methods (vapor-phase film formation) are preferred. When the dry plating methods (vapor-phase film forming) are used to form the oxide coating 3, the coating has a uniform layer thickness, the layer is homogeneous, and the formation of an oxide layer having excellent adhesion with the substrate 2 is assured. As a result, the ultimately obtained decorative article 1 has exceptional aesthetic appeal and durability. When the dry type plating methods (vapor-phase film forming) are used to form the oxide coating 3, there is minimal variance in the layer thickness even when the coating of the oxide coating 3 is relatively thin. Therefore, for example, the durability of the obtained decorative article 1 is sufficiently improved and radio wave transmittance by the decorative article 1 is improved. Accordingly, the obtained decorative article 1 is optimally suited for radio watch components.

Among the dry type plating methods (vapor-phase film forming) described above, the sputtering method is particularly desirable. Using a sputtering method to form the oxide coating 3 remarkably enhances the aforementioned effects. In other words, when the oxide coating 3 is formed by a sputtering method, the obtained oxide coating 3 is homogeneous, has uniform thickness, and provides exceptional adhesion with the substrate 2. As a result, the ultimately obtained decorative article 1 has unsurpassed aesthetic appeal and durability. Furthermore, when the oxide coating 3 is formed by a sputtering method, variation in the coating thickness is minimized even when the oxide coating 3 is relatively thin. Therefore, for example, the durability of the obtained decorative article 1 is sufficiently improved and radio wave transmittance by the decorative article 1 is improved. Accordingly, the obtained decorative article 1 is optimally suited for radio watch components.

When the previously mentioned dry plating methods are used, for example, when using a metal corresponding to the metal oxide forming the oxide coating 3 as the target, the oxide coating 3 can be easily and reliably formed by a process in an atmosphere containing oxygen gas.

Forming the oxide coating 3 also may be accomplished by using a plurality of different methods under various combinations of conditions. In this way an oxide coating 3 having a laminate structure can be optimally formed.

Metal Coating Forming Process

Next, as shown in line c of FIG. 2, the metal coating 4 formed mainly of metal material is formed on the previously formed oxide coating 3.

The method for forming the metal coating 4 is not specifically limited. Examples of usable methods include applications such as spin coating, dip coating, brush application, spray application, electrostatic application, electro deposition, and the like, wet plating methods such as electrolytic plating, immersion plating, electroless plating, and the like, chemical deposition methods (CVD) such as heat CVD, plasma CVD, laser CVD and the like, dry plating methods (vapor-phase film formation) such as vacuum vapor deposition, sputtering, ion plating, and the like, and spray coating and the like, among which the dry plating methods (vapor-phase film formation) are preferred. When the dry plating methods (vapor-phase film forming) are used to form the metal coating 4, the coating has a uniform layer thickness, the layer is homogeneous, and the formation of an oxide layer having excellent adhesion with the oxide coating 3 is assured. As a result, the ultimately obtained decorative article 1 has exceptional aesthetic appeal and durability. When the dry type plating methods (vapor-phase film forming) are used to form the metal coating 4, there is minimal variance in the layer thickness even when the coating of the metal coating 4 is relatively thin. Therefore, for example, the durability of the obtained decorative article 1 is sufficiently improved and radio wave transmittance by the decorative article 1 is improved. Accordingly, the obtained decorative article 1 is optimally suited for radio watch components.

Among the dry type plating methods (vapor-phase film forming) described above, the sputtering method is particularly desirable. Using a sputtering method to form the metal coating 4 remarkably enhances the aforementioned effects. In other words, when the metal coating 4 is formed by a sputtering method, the obtained metal coating 4 is homogeneous, has uniform thickness, and provides exceptional adhesion with the oxide coating 3. As a result, the ultimately obtained decorative article 1 has unsurpassed aesthetic appeal and durability. Furthermore, when the metal coating 4 is formed by a sputtering method, variation in the coating thickness is minimized even when the metal coating 4 is relatively thin. Therefore, for example, the durability of the obtained decorative article 1 is sufficiently improved and radio wave transmittance by the decorative article 1 is improved. Accordingly, the obtained decorative article 1 is optimally suited for radio watch components.

When the previously mentioned dry plating methods are used, for example, when using a metal to form the metal coating 4 as the target, the metal coating 4 can be easily and reliably formed by a process in an atmosphere containing an inactive gas, such as argon gas, and the like. When using a dry plating method in the oxide coating forming process, for example, the oxide coating forming process and metal coating forming process can be performed continuously within the same apparatus by, for example, changing the target as necessary, and exchanging the oxygen gas for inactive gas as a component of the atmosphere gas in the vapor-phase film forming apparatus (chamber). In this way the decorative article 1 has exceptional adhesion between the substrate 2, oxide coating 3, and metal coating 4, and mass production characteristics are improved.

Forming the metal coating 4 also may be accomplished using a plurality of different methods under various combinations of conditions. In this way a metal coating 4 having a laminate structure can be optimally formed.

Cover Layer Forming Process

Next, the cover layer 5 is formed on the previously formed metal coating 4 (2d).

The method for forming the cover layer 5 is not specifically limited. Examples of usable methods include applications such as spin coating, dip coating, brush application, spray application, electrostatic application, electro deposition and the like, wet plating methods such as electrolytic plating, immersion plating, electroless plating, and the like, chemical deposition methods (CVD) such as heat CVD, plasma CVD, laser CVD, and the like, dry plating methods (vapor-phase film formation) such as vacuum vapor deposition, sputtering, ion plating and the like, and spray coating, and the like, among which the application methods are preferred when the cover layer 5 is formed mainly of resin material. Consequently, the cover layer 5 can be formed with relative ease. When forming the cover layer 5 using an application method, colorant and similar constituents can be added to the material forming the cover layer, and the amount of such additives can be easily adjusted.

The watch of the present invention provided with the decorative article of the present invention is described below.

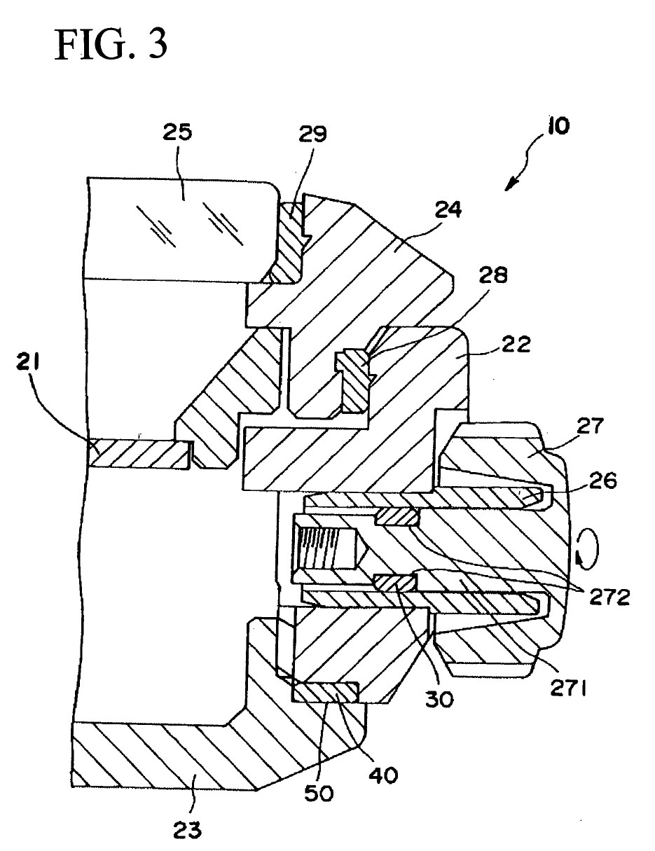

FIG. 3 is a cross section view of a watch (wristwatch) having the decorative article of a preferred embodiment of the present invention.

As shown in FIG. 3, a wristwatch (portable) 10 according to the present embodiment is provided with a case 22, back cover 23, bezel (edge) 24, and glass plate 25. A watch dial 21 using the decorative article of the present invention is housed within the case 22. Watch hands not shown in the drawing are housed within the case 22 in a space formed between the glass plate 25 and watch dial 21, and a watch movement not shown in the drawing is accommodated within the case 22 in a space formed between the watch dial 21 and the back cover 23.

A winding pipe 26 is inserted and fixed to the case 22, and a shaft 271 of a winding stem 27 is inserted into the winding pipe 26 to be rotatable. The case 22 and bezel 24 are fixed by a plastic packing 28, and the bezel 24 and glass plate 25 are fixed by a plastic packing 29.

The back cover 23 is engagingly inserted (or screwed) into the case 22, and a ring-like rubber packing (back cover packing) 40 resides in a compressed state in a connection (seal) 50 of the case 222 and cover 23. According to this structure, the seal 50 seals against moisture and provides a waterproofing function.

A channel 272 is formed on the intermediate external surface of the shaft 271 of the winding stem 27, and a ring-like rubber packing (winding stem packing) 30 is inserted into this channel 272. The rubber packing 30 adheres to the inner surface of the winding pipe 26, and is compressed between the channel 272 and this inner surface. This structure provides a waterproofing function by sealing out moisture between the winding stem 27 and winding pipe 26. When the winding stem 27 is rotated, the rubber packing 30 rotates together with the shaft 271, and oscillates in a circumferential direction closely adhered to the inner surface of the winding pipe 26.

Although the decorative article of the present invention is used as a watch dial in the above description, the decorative article of the present invention may also be applied to components (decorative articles) other than a watch dial. Although the present invention is described above in terms of a preferred embodiment, the invention is not limited to this embodiment.

For example, the decorative article manufacturing process of the present invention may add other optional processes as necessary. In other words, for example, intermediate cleaning processes and the like may be added between the oxide coating forming process and metal coating forming process, and between the metal coating forming process and the cover layer forming process. Furthermore, post-processes, such as polishing (lapping), may be added after the cover layer forming process. Moreover, pre-processing of the substrate may be added prior to the oxide coating forming process.

Although the decorative article has been described as being provided with a cover layer in the above embodiment, the decorative article need not be provided with a cover layer.

The above embodiment has been described in terms of the substrate being adjacent to the oxide coating, and the oxide coating being adjacent to the metal coating, however, one or more intermediate layers may be interposed therebetween, for example.

### EXAMPLE

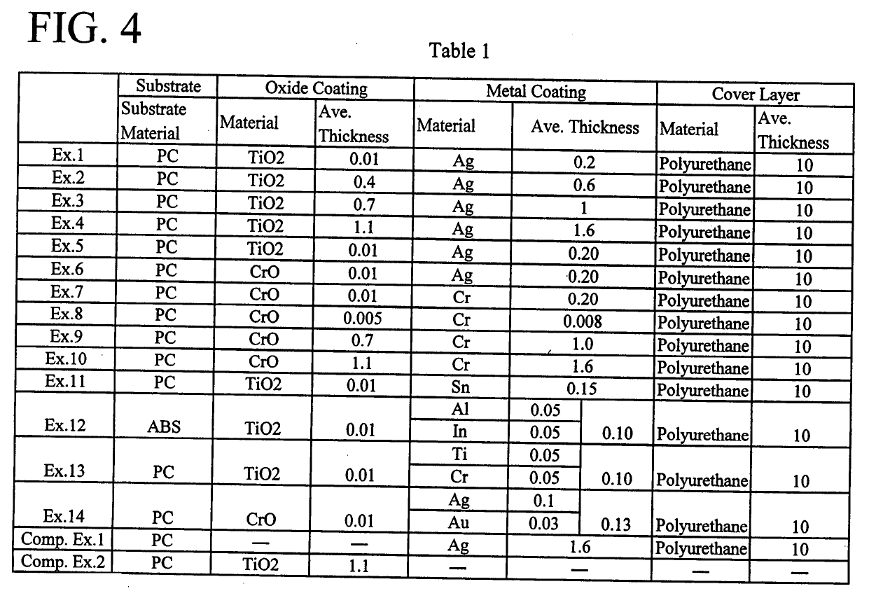

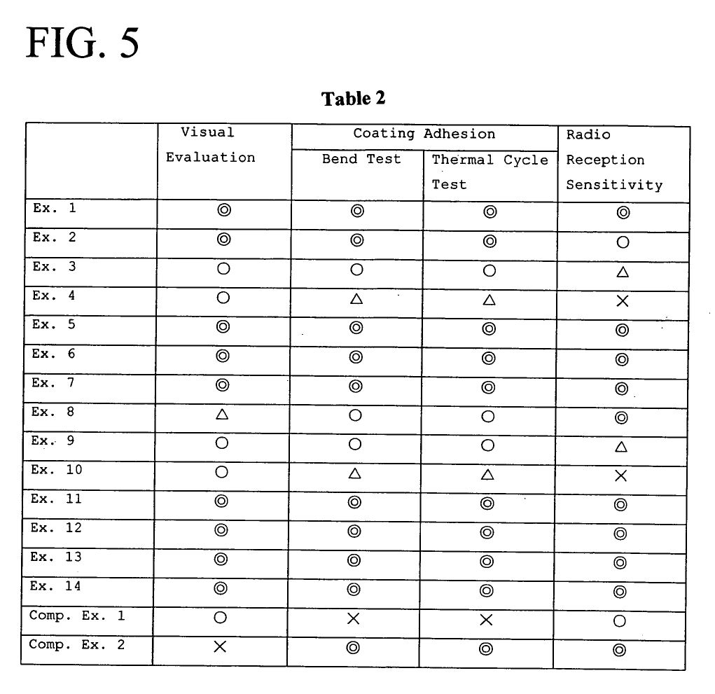

Specific examples of the present invention are described below with reference to FIGS. 4 to 5.

1. Decorative Article Fabrication

### Example 1

A decorative articles external component of a wristwatch (watch dial) was manufactured by the method described below.

First a substrate 2 in the shape of a wristwatch external component (watch dial) was manufactured by compression molding using polycarbonate, and thereafter required locations were machined and polished. The obtained substrate 2 had an approximate disk-like shape, with an approximate diameter of 27 mm and approximate thickness of 0.5 μm.

The substrate 2 was then washed. Washing the substrate 2 was accomplished first by alkaline electrolytic degreasing for 30 seconds, then by alkaline immersion degreasing for 30 seconds. Thereafter, it was neutralized for 10 seconds, washed in water for 10 seconds, and washed in purified water for 10 seconds.

An oxide coating 3 of TiO₂ was formed on the surface of the washed substrate 2 by a sputtering method described below (oxide coating forming process).

First, the washed substrate 2 was mounted in a sputtering apparatus, and thereafter air was evacuated from the sputtering apparatus interior to a pressure of 3>10⁻³ Pa (vacuum) while “preheating” the interior of the apparatus. Next, argon gas was introduced into the chamber at a flow rate of 40 ml/minute, and oxygen gas was introduced into the chamber at a flow rate of 10 ml/minute. In this condition, Ti was used as a target, and an oxide coating 3 of TiO₂ was formed by electro-discharge using power input of 1500 W and processing time of 0.5 minutes. The average thickness of the oxide coating 3 formed in this manner was 0.01 μm.

Continuing, a metal coating 4 of Ag was formed on the surface of the previously formed oxide coating 3 by sputtering as described below (metal coating forming process).

First, the apparatus interior was evacuated to a pressure of 3×10⁻³ Pa (vacuum), and thereafter argon gas was introduced at a flow rate of 35 ml/minute. In this condition, Ag was used as a target, and a metal coating 4 of Ag was formed by electro-discharge using power input of 1500 W and processing time of 2.5 minutes. The average thickness of the metal coating 4 formed in this manner was 0.20 μm.

The obtained substrate 2 covered by the oxide coating 3 and the metal coating 4 was then washed. Washing the substrate 2 was accomplished first by alkaline immersion degreasing for 30 seconds, then being neutralized for 10 seconds, washed in water for 10 seconds, and washed in purified water for 10 seconds.

Thereafter a cover layer 5 of polyurethane was formed on the metal coating 4 (cover layer forming process). The cover layer 5 was formed by the sputtering method. The average thickness of the formed cover layer 5 was 10 μm.

The thicknesses of the oxide coating 3, metal coating 4, and cover layer 5 were measured by the microscopic section test method stipulated in JIS H5821.

### Examples 2 through 4

Decorative articles 1 (wristwatch external components (watch dials)) were manufactured in the same manner as example 1 with the exception that the average thicknesses of the oxide coating 3 and metal coating 4 were changed as shown in Table 1 of FIG. 4 by changing the processing times of the oxide coating 3 forming process and the metal coating 4 forming process.

### Example 5

A decorative article 1 (wristwatch external component (watch dial)) was manufactured in the same manner as example 1 with the exception that acrylonitrile-butadiene-styrene copolymer (ABS resin) was used as the structural material of the substrate 2.

### Example 6

A decorative article 1 (wristwatch external component (watch dial)) was manufactured in the same manner as example 1 with the exception that electro-discharge was performed under conditions of Cr used as the target, argon gas flow rate was 40 ml/minute, oxygen gas flow rate was 10 ml/minute, power input was 1000 W, and processing time was 30 seconds when forming the oxide coating 3 (oxide coating forming process). The obtained oxide coating 3 was formed of Cr, and its average thickness 0.01 μm.

### Example 7

A decorative article 1 (wristwatch external component (watch dial)) was manufactured in the same manner as example 6 with the exception that electro-discharge was performed under conditions of Cr used as the target, argon gas flow rate was 20 ml/minute, power input was 500 W, and processing time was 5 minutes when forming the metal coating 4 (metal coating forming process). The obtained metal coating 4 was formed of Cr, and its average thickness was 0.20 μm.

### Examples 8 through 10

Decorative articles 1 (wristwatch external components (watch dials)) were manufactured in the same manner as example 7 with the exception that the average thicknesses of the oxide coating 3 and metal coating 4 were changed as shown in Table 1 FIG. 4 by changing the processing times of the oxide coating 3 forming process and the metal coating 4 forming process.

### Example 11

A decorative article 1 (wristwatch external component (watch dial)) was manufactured in the same manner as example 1 with the exception that electro-discharge was performed under conditions of Sn used as the target, argon gas flow rate was 20 ml/minute, power input was 1000 W, and processing time was 2 minutes when forming the metal coating 4 (metal coating forming process). The obtained metal coating 4 was formed of Sn, and its average thickness was 0.15 μm.

### Example 12

A decorative article 1 (wristwatch external component (watch dial)) was manufactured in the same manner as example 5 with the exception that the metal coating 4 was formed as a laminate body having an Al layer formed of Al, and In layer formed of In. The Al layer and In layer were in each case formed by sputtering.

The Al layer was formed under electro-discharge condition of Al used as the target, argon gas flow rate was 30 ml/minute, power input was 1500 W, and processing time was 1 minute.

The In layer was formed under electro-discharge condition of In used as the target, argon gas flow rate was 30 ml/minute, power input was 1600 W, and processing time was 1 minute.

The average thicknesses of the obtained Al layer and In layer were respectively 0.05 μm and 0.05 μm. The Al layer was on the side in contact with the oxide coating 3, and the In layer was on the side in contact with the cover layer 5.

### Example 13

A decorative article 1 (wristwatch external component (watch dial)) was manufactured in the same manner as example 1 with the exception that the metal coating 4 was formed as a laminate body having an Ti layer formed of Ti, and Cr layer formed of Cr. The Ti layer and Cr layer were in each case formed by sputtering.

The Ti layer was formed under electro-discharge condition of Ti used as the target, argon gas flow rate was 20 ml/minute, power input was 600 W, and processing time was 3 minute.

The Cr layer was formed under electro-discharge condition of Cr used as the target, argon gas flow rate was 30 ml/minute, power input was 500 W, and processing time was 1.5 minutes.

The average thicknesses of the obtained Ti layer and Cr layer were respectively 0.05 μm and 0.05 μm. The Ti layer was on the side in contact with the oxide coating 3, and the Cr layer was on the side in contact with the cover layer 5.

### Example 14

A decorative article 1 (wristwatch external component (watch dial)) was manufactured in the same manner as example 6 with the exception that the metal coating 4 was formed as a laminate body having an Ag layer formed of Ag, and Au layer formed of Au.

The Ag layer and Au layer were in each case formed by sputtering.

The Ag layer was formed under electro-discharge condition of Ag used as the target, argon gas flow rate was 35 ml/minute, power input was 1700 W, and processing time was 1 minute. The Au layer was formed under electro-discharge condition of Au used as the target, argon gas flow rate was 30 ml/minute, power input was 1700 W, and processing time was 30 seconds.

The average thicknesses of the obtained Ag layer and Au layer were 0.10 μm and 0.03 μm, respectively. The Ag layer was on the side in contact with the oxide coating 3, and the Au layer was on the side in contact with the cover layer 5.

### Comparative Example 1

A decorative article 1 (wristwatch external component (watch dial)) was manufactured in the same manner as example 4 with the exception that the metal coating 4 was formed directly on the surface of the washed substrate without forming the oxide coating 3.

### Comparative Example 2

A decorative article 1 (wristwatch external component (watch dial)) was manufactured in the same manner as example 4 with the exception that the metal coating 4 and cover layer 5 were not formed after forming the oxide coating 3.

The structure of the decorative articles 1 of the examples and comparative examples are shown in Table 1 of FIG. 4. In Table 1 of FIG. 4, polycarbonate is abbreviated as PC, and acrylonitrile-butadiene-styrene copolymer (ABS resin) is abbreviated as ABS.

2. Aesthetic Evaluation of Decorative Articles

The decorative articles manufactured in examples 1 through 14, and comparative examples 1 and 2 were subjected to visual and microscopic examination, and their appearance was evaluated according to four rating criteria described below, which are listed in order of preference.
⊚: Excellent appearance
◯: Good appearance
Δ: Fair appearance
x: Poor appearance
   3. Coating (Oxide Coating, Metal Coating) Adhesion Evaluation

The decorative articles manufactured in examples 1 through 14, and comparative examples 1 and 2 were subjected to two types of testing described below to evaluate adhesion of the coatings (oxide coating and metal coating).

3-1. Bend Test

Each decorative article was supported on a metal rod 4 mm in diameter and bent 30° using the center of the decorative article as a reference. Subsequently, the decorative article was examined visually, and the external appearance was evaluated on the basis of four rating levels described below, which are listed in order of preference. Bending was accomplished in both compression and pull directions.
⊚: Coating completely free of lifting and peeling
◯: Coating mostly free of lifting
Δ: Lifting of the coating clearly observed
x: Crazing (stress crack) and peeling of coating clearly visible
   3-2. Thermal Cycle Test

Each decorative article was subjected to the thermal cycle test as described below.

First, the decorative article was maintained at rest in an environment of 20° C. for 1.5 hours, then an environment of 60° C. for 2 hours, then an environment of 20° C. for 1.5 hours, then an environment of −20° C. for 3 hours. Subsequently, the decorative article was again returned to an environment of 20° C. for one cycle (8 hours), and this cycle was repeated a total of three times (total: 24 hours). Thereafter, the decorative article was examined visually, and the external appearance was evaluated on the basis of four rating levels described below, which are listed in order of preference.
⊚: Coating completely free of lifting and peeling
◯: Coating mostly free of lifting
Δ: Lifting of the coating clearly observed
x: Crazing (stress crack) and peeling of coating clearly visible
   4. Radio Reception Sensitivity Evaluation

The decorative articles of examples 1 through 14 and comparative examples 1 and 2 were evaluated for radio reception sensitivity by the method described below.

First, a watch case and an internal module (movement) were prepared for a wristwatch provided with an antenna for radio reception. Then, the internal module (movement) of the wristwatch and a watch dial as a decorative article were assembled in the watch case, and in this state radio reception sensitivity was measured. Using reception sensitivity when the watch dial was not in the assembly as a reference basis, reception sensitivity with the watch dial in the assembly was evaluated on the basis of four rating levels of sensitivity decrease (dB) described below which are listed in order of preference.
⊚: No measurable loss of sensitivity (below detection limit)
◯: Sensitivity loss less than 1 dB
Δ: Sensitivity loss more than 1 dB, but less than 1.2 dB
x: Sensitivity loss greater than 1.2 dB
   The results are shown in Table 2 of FIG. 5.

As Table 2 of FIG. 5 makes clear, the decorative articles of the present invention invariably have a superior aesthetic appearance, and excellent adhesion if the coatings (oxide coating and metal coating) are provided according to the present invention. Furthermore, when the average thickness of the coatings (oxide coating and metal coating) were values within the desirable range, the decorative articles had exceptional aesthetic appeal and excellent radio reception sensitivity. From these data it can be concluded that these decorative articles are optimally suited for radio controlled timepiece.

In contrast, unsatisfactory results were obtained by the comparative examples. That is, poor coating (metal coating) adhesion was obtained in the decorative article of comparative example 1 which was not provided with an oxide coating 3. Furthermore, poor appearance was obtained in the decorative article of comparative example 2 which was not provided with a metal coating 4.

Moreover, the watch shown in FIG. 3 was assembled using the watch dials (decorative articles) obtained in the examples and comparative examples. Each of the watches was subjected to evaluation using the thermal cycle test and radio reception sensitivity test, and the results were identical to the previous results.

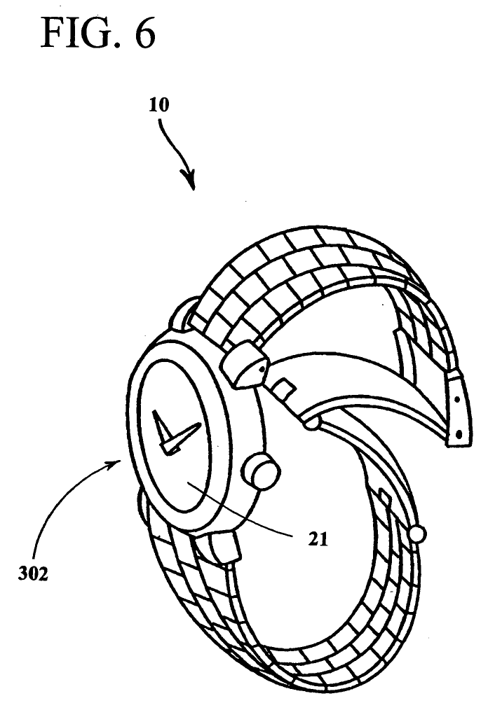

As shown in FIGS. 6 and 7, the timepiece 10 of the present embodiment preferably includes a drive unit 301 and a display unit 302 that has the dial 21 and a time indicator 304.

As used herein, the following directional terms “forward, rearward, above, downward, vertical, horizontal, below, and transverse” as well as any other similar directional terms refer to those directions of a device equipped with the present invention. Accordingly, these terms, as utilized to describe the present invention should be interpreted relative to a device equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2004-026129. The entire disclosure of Japanese Patent Application No. 2004-026129 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A decorative article comprising:
a substrate being formed of plastic material;
an oxide coating being formed of a metal oxide provided on said substrate; and
a metal coating being formed of a metal material provided on a first surface of said oxide coating, said first surface being opposite a second surface facing said substrate.

2. The decorative article according to claim 1, wherein said substrate is formed of material that includes at least one material selected from the group consisting of polycarbonate and acrylonitrile-butadiene-styrene copolymer.

3. The decorative article according to claim 2, wherein said oxide coating is formed of material that includes at least one material selected from the group consisting of titanium oxide and chromium oxide.

4. The decorative article according to claim 1, wherein said oxide coating is formed of material that includes at least one material selected from the group consisting of titanium oxide and chromium oxide.

5. The decorative article according to claim 4, wherein the average thickness of said oxide coating is from 0.01 to 1.0 μm.

6. The decorative article according to claim 2, wherein the average thickness of said oxide coating is from 0.01 to 1.0 μm.

7. The decorative article according to claim 1, wherein the average thickness of said oxide coating is from 0.01 to 1.0 μm.

8. The decorative article according to claim 1, wherein said metal coating is formed of material that includes at least one material selected from the group consisting of Ag, Cr, Au, Al, Ti, Sn, and In.

9. The decorative article according to claim 1, wherein the average thickness of said metal coating is from 0.01 to 1.5 μm.

10. The decorative article according to claim 1, wherein the sum of the average thickness of said oxide coating and the average thickness of said metal coating is from 0.02 to 2.5 μm.

11. The decorative article according to claim 1, wherein a cover layer formed of resin material is provided on said metal coating.

12. The decorative article according to claim 9, wherein said cover layer is formed of urethane resin and/or acrylic resin.

13. A watch comprising:
a drive unit; and
a display unit being configured to display time having,
a dial having
a substrate being formed of plastic material,
an oxide coating being formed of a metal oxide provided on said substrate, and
a metal coating being formed of a metal material provided on a first surface of said oxide coating, said first surface being opposite a second surface facing said substrate, said decorative article being an external decorative article, and
a time indicator being connected to said drive unit and located on said dial.

14. The watch according to claim 13, further comprising components configured to provide radio wave transmittance.

15. A method for manufacturing a decorative article comprising:
preparing a substrate having plastic material;
forming an oxide coating having a metal oxide on at least part of a surface of said substrate; and
forming a metal coating having a metal material on at least part of a surface of said oxide coating.

16. The method for manufacturing a decorative article according to claim 15, wherein
forming said oxide coating is accomplished by a vapor-phase layer forming method.

17. The method for manufacturing a decorative article according to claim 15, wherein
forming said oxide coating is accomplished by a sputtering method.

18. The method for manufacturing a decorative article according to claim 15, wherein
forming said metal coating is accomplished by a vapor-phase layer forming method.

19. The method for manufacturing a decorative article according to claim 17, wherein
forming said metal coating is accomplished by a sputtering method.

20. The method for manufacturing a decorative article according to claims 15, further comprising,
forming a cover layer having a resin material after forming said metal coating.
